(19) United States
(12) Patent Application Publication
(10) Pub. No.: US 2025/0343661 A1
(43) Pub. Date: Nov. 6, 2025

(54) TCI CONTROL METHOD ACROSS FD AND NON-FD SYMBOLS

(71) Applicant: InterDigital Patent Holdings, Inc., Wilmington, DE (US)

(72) Inventors: Jonghyun PARK, Syosset, NY (US); Moon IL Lee, Melville, NY (US); Nazli Khan Beigi, Longueuil (CA); Aata El Hamss, Laval (CA); Virgile Garcia, Antibes (FR); Paul Marinier, Brossard (CA)

(73) Assignee: InterDigital Patent Holdings, Inc., Wilmington, DE (US)

(21) Appl. No.: 18/656,102

(22) Filed: May 6, 2024

(51) Int. Cl. H04L 5/00; H04L 5/14

(52) U.S. Cl. CPC H04L 5/0091; H04L 5/14

(57) ABSTRACT

Methods and devices are disclosed for using subband full duplex (SBFD) symbols and non-SBD symbols based on associated transmission control indicator (TCI) states. In one method, a WTRU receives a first downlink control information (DCI) indicating a first TCI state associated with non-SBFD symbol transmissions and/or receptions with a network and receives a second DCI indicating a second TCI state associated with SBFD symbol transmissions and/or receptions with the network. In various solutions, a TCI field in the received DCIs indicates by codepoints the TCI states for SBFD and/or non-SBFD states. Additional embodiments are disclosed.

### BACKGROUND

New Radio (NR) duplex operation has been proposed for in improving conventional time division duplex (TDD) operation for enhancing uplink (UL) coverage, improving capacity, reducing latency, and the like. Conventional TDD is based on splitting the time domain of a radio frame between the uplink and downlink. The feasibility of allowing full duplex, or more specifically, subband non-overlapping full duplex (SBFD) at the gNB with a conventional TDD band is undergoing study and faces certain challenges including cross-layer interferences (CLI).

Certain issues relate to separate quasi-colocation (QCL)/transmission configuration indicator (TCI) configurations for SBFD symbol types and non-SBFD symbol types. By reusing the TCI framework for a multi-transmission and reception point (TRP) scenario, there are different interference natures for the different symbol-types, including non-negligible self-interference when using a downlink (DL) beam on SBFD symbols. However, reusing the TCI framework may result in losing TCI control flexibility across multiple TRPs, whereas the SBFD operation should be able to work within a single TRP as a baseline, not relying on the multi-TRP extended TCI framework. Solutions are needed for how to achieve such separated beam/TCI control across different SBFD symbol types, even within a single TRP scenario as a basis for beam/TCI control. Solutions are needed for how to dynamically indicate separate TCI states for SBFD symbols and non-SBFD symbols, particularly with reduced signaling overhead using a unified TCI framework

### SUMMARY

Methods and devices are disclosed which may address one or more of the previously-mentioned issues. According to various aspects, methods of implicitly or explicitly determining a mapping between an indicated TCI state and a full duplex (FD) symbol type (e.g., SBFD and non-SBFD) for transmissions and/or receptions are disclosed.

In one aspect, a user equipment (UE), also referred to herein as a wireless transmit receive unit (WTRU), may performing a method including receiving configuration information for subband full duplex (SBFD) communication and a plurality of transmission configuration indicator (TCI) states; receiving a TCI activation command indicating an activated set of TCI states of the configured plurality of TCI states. The WTRU receives a first downlink control information (DCI) indicating a first TCI state of an activated set of TCI states and associates the first TCI state with non-SBFD symbol transmissions and/or receptions with a network. The WTRU then sends or receives signals using the first TCI state on one or more of non-SBFD, and optionally also SBFD symbols. This may continue until a SBFD-specific TCI control command is received from the network.

In an example, the WTRU receives a second DCI indicating a second TCI state of the activated set of TCI states and associates the second TCI state with SBFD symbol transmissions and/or receptions. The WTRU may receive or send a second signal/channel using the first TCI state on non-SBFD symbols; and receive or send a third signal/channel using the second TCI state on SBFD symbols.

In various aspects, the SBFD symbols include non-overlapping SBFD symbols including one or more SBFD subbands and the non-SBFD symbols comprise time division duplex (TDD) symbols without SBFD subbands.

In various aspects, the first, second or third signals may include any one of a control channel, a data channel or a reference signal.

According to some aspects, the WTRU associates the first TCI state with non-SBFD symbol transmissions or receptions based on one of: a symbol type in which the first DCI is received, an identity or type of CORSET, a search space and search space set in which the first DCI is received, a reception timing of the first DCI or time offset from the reception time of the first DCI, the configuration information for SBFD communication, an explicit indication from the network, or a DCI type of the first DCI.

According to some aspects, the WTRU associates the second TCI state with SBFD symbol transmissions or receptions is based on one of: a symbol type in which the second DCI is received, an identity or type of CORSET, a search space and search space set in which the second DCI is received, a reception timing of the second DCI or time offset from the reception time of the second DCI, the configuration information for SBFD communication, an explicit indication from the network, or a DCI type of the second DCI.

In other aspects, the first TCI state is a unified TCI (UTCI) state for transmitting or receiving a signal on either or both of SBFD or non-SBFD symbols. In various examples, the configuration information includes a mapping between one or more codepoints of a DCI field and one or more TCI states of the plurality of TCI states. According to various aspects, the first DCI and the second DCI includes the DCI field, and each of the one or more TCI states is applicable after a time duration based on a beam application time (BAT) parameter. Additional aspects, features and advantages may become apparent from the description of the embodiments which follow.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram showing an example of a subband non-overlapping full duplex (SBFD) configuration in a time division duplex (TDD) framework;

FIG. 3 is network diagram showing example cross-layer interference (CLI) of Inter-gNBs and Inter-WTRUs;

FIG. 4 is an illustrative example of a downlink control information (DCI) field for unified transmission configuration indicator (UTCI);

FIG. 5 is timing diagram showing a method of TCI or beam control access across full duplex and non-full duplex symbols according to an example embodiment;

FIG. 6 is a flow diagram illustrating a method for a wireless transmit receive unit (WTRU) communicating in different TCI states using non-SBFD symbols and SBFD symbols according to an example embodiment;

FIG. 7 is an illustrative example of a TCI field of a DCI for UTCI state indications based on a medium access control (MAC) control element (CE) activation for separated TCI control across different symbol types; and

FIG. 8 is another illustrative example of a TCI field of a DCI for UTCI state indications based on a medium access control (MAC) control element (CE) activation for separated TCI control across different symbol types.

### DETAILED DESCRIPTION

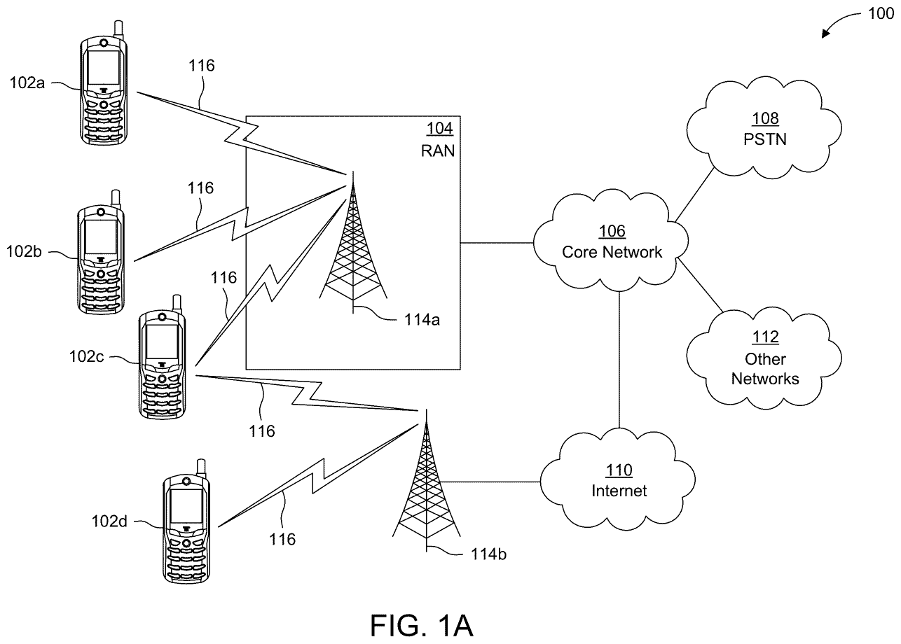

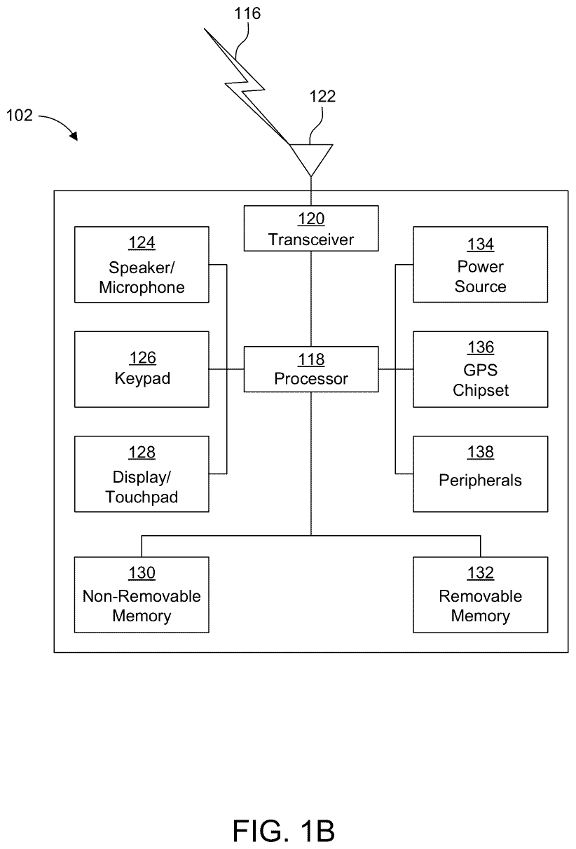

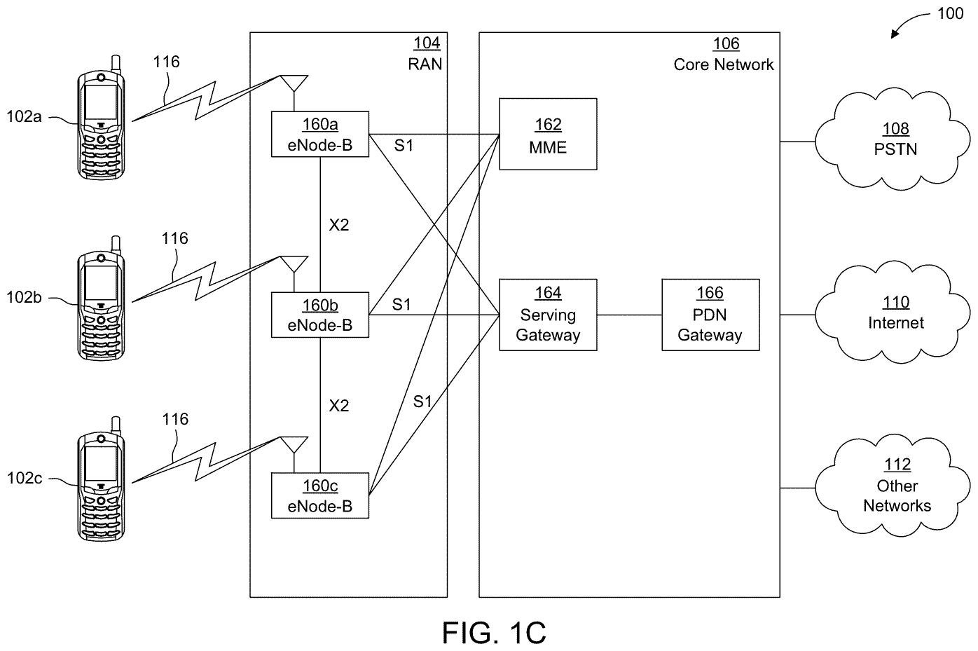

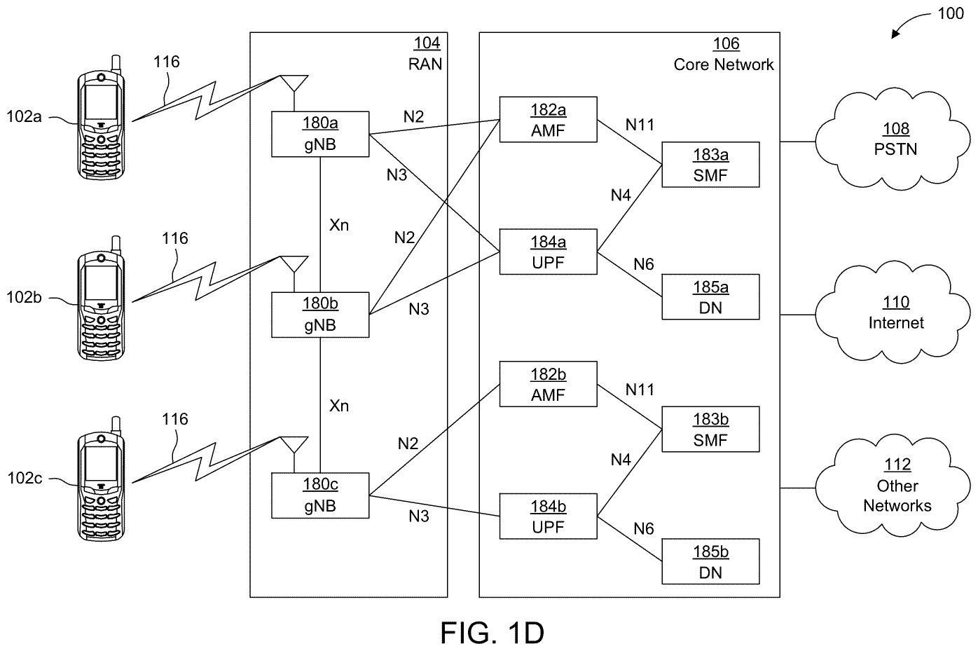

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

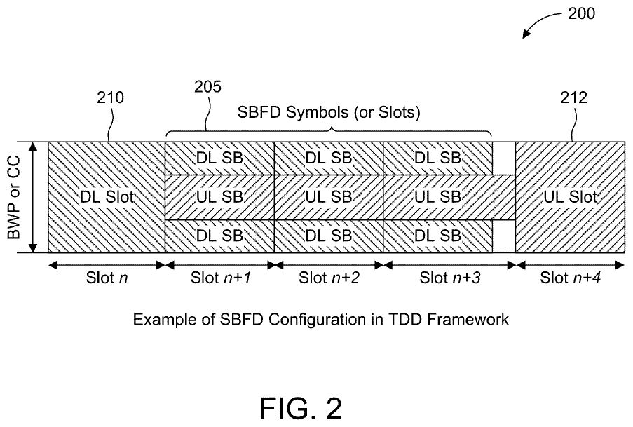

As mentioned previously, New Radio (NR) duplex operation is being studied for improving conventional time division duplex (TDD) operation by enhancing UL coverage, improving capacity, reducing latency, etc. The conventional TDD is based on splitting the time domain between the uplink and downlink in a radio frame. Referring to FIG. 2, an example of a partial NR frame 200 is shown having both subband non-overlapping full duplex (SBFD) symbols (or slots) 205 and conventional TDD symbols (or slots) 210, 212, the latter of which may also be referred to herein as non-SBFD symbols or slots.

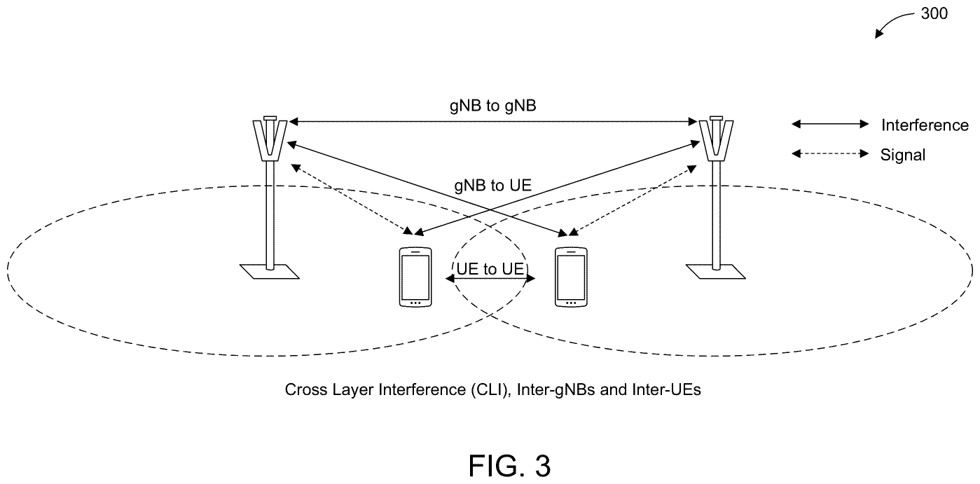

Referring to FIG. 3, the realization of SBFD is subject to resolving the key challenges raised due to cross-layer interferences (CLI). In a SBFD (or dynamic/flexible TDD) framework, a potential aggressor cell may switch from UL to DL or vice-versa, causing CLI on potential victim gNBs and WTRUs. In UL-to-DL CLI, the UL transmission from aggressor WTRUs may cause directional CLI at the victim WTRUs, as shown in diagram 300. The CLI can be measured at both the victim and/or aggressor WTRUs.

In developing NR-Duplex, issues have been identified for separate QCL/TCI configurations for SBFD symbol types and non-SBFD symbol types. For example, in reusing the basic TCI framework for multi-TRP scenarios, there are different interference natures for the different symbol types, including non-negligible self-interference when using a DL beam on SBFD symbols. Reusing the existing TCI framework may result in losing TCI control flexibility across multiple TRPs, whereas the SBFD operation should be able to work within a single TRP as a baseline, not relying on multi-TRP extended TCI framework. Solutions are described herein to provide separate beam/TCI control across different SBFD symbol types within a single TRP scenario as a basis for beam/TCI control. Specifically, solutions to dynamically indicate separate TCI states for SBFD symbols and non-SBFD symbols may be provided with the reduced signaling overhead of the unified TCI (UTCI) framework.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’.

Hereinafter, the term “subband” is used to refer to a frequency-domain resource and may be characterized by at least one of the following: a set of resource blocks (RBs); a set of resource block sets (RB sets), e.g. when a carrier has intra-cell guard bands; a set of interlaced resource blocks; a bandwidth part, or portion thereof; or a carrier, or portion thereof. For example, a subband may be characterized by a starting RB and number of RBs for a set of contiguous RBs within a bandwidth part. A subband may also be defined by the value of a frequency-domain resource allocation field and bandwidth part index.

Hereinafter, the term “XDD” is used to refer to a subband-wise duplex (e.g., either UL or DL being used per subband) and may be characterized by at least one of the following: Cross division duplex (e.g., subband-wise FDD within a TDD band); subband-based full duplex (e.g., full duplex as both UL and DL are used/mixed on a symbol/slot, but either UL or DL being used per subband on the symbol/slot); frequency-domain multiplexing (FDM) of DL/UL transmissions within a TDD spectrum; a subband non-overlapping full duplex (SBFD) (e.g., non-overlapped sub-band full-duplex); a full duplex other than a same-frequency (e.g., spectrum sharing, subband-wise-overlapped) full duplex; an advanced duplex method, e.g., other than (pure) TDD or FDD.

Hereinafter, the term “dynamic (/flexible) TDD” is used to refer to a TDD system/cell which may dynamically (and/or flexibly) change/adjust/switch a communication direction (e.g., a downlink, an uplink, or a sidelink, etc.) on a time instance (e.g., slot, symbol, subframe, and/or the like). In an example, in a system employing dynamic/flexible TDD, a component carrier (CC) or a bandwidth part (BWP) may have one single type among ‘D’, ‘U’, and ‘F’ on a symbol/slot, based on an indication by a group-common (GC)-downlink control information (DCI) (e.g., Format 2_0) including a slot format indicator (SFI), and/or based on tdd-UL-DL-config-common/dedicated configurations. On a given time instance/slot/symbol, a first gNB (e.g., cell, TRP) employing dynamic/flexible TDD may transmit a downlink signal to a first WTRU being communicated/associated with the first gNB based on a first SFI and/or tdd-UL-DL-config configured/indicated by the first gNB, and a second gNB (e.g., cell, TRP) employing dynamic/flexible TDD may receive an uplink signal transmitted from a second WTRU being communicated/associated with the second gNB based on a second SFI and/or tdd-UL-DL-config configured/indicated by the second gNB. In an example, the first WTRU may determine that the reception of the downlink signal is being interfered by the uplink signal, where the interference caused by the uplink signal may refer to a WTRU-to-WTRU cross-layer interference (CLI).

A WTRU may transmit or receive a physical channel or reference signal according to at least one spatial domain filter. The term “beam” may be used to refer to a spatial domain filter. The WTRU may transmit a physical channel or signal using the same spatial domain filter as the spatial domain filter used for receiving a reference signal (RS) (e.g., such as channel state information reference signal (CSI-RS)) or a synchronization signal (SS) block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by radio resource control (RRC) or signaled by medium access control (MAC) control element (CE) or DCI. For example, a WTRU may implicitly transmit a PUSCH and demodulation reference signal (DM-RS) of the PUSCH according to the same spatial domain filter as a sounding reference signal (SRS) indicated by an SRS resource indicator (SRI) indicated in DCI or configured by RRC. In another example, a spatial relation may be configured by RRC for an SRI or signaled by MAC CE for a PUCCH. Such spatial relation may also be referred to as a “beam indication.”

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS or SS block and a DM-RS by an index to a set of TCI states configured by RRC and/or signaled by MAC CE. Such indication may also be referred to as a “beam indication”.

A unified TCI (UTCI) (e.g., a common TCI, a common beam, a common RS, etc.) may refer to a beam/RS to be (simultaneously) used for multiple physical channels/signals. The term “TCI” may at least include a TCI state having at least one source RS to provide a reference (e.g., WTRU assumption) for determining a QCL and/or spatial filter.

In an example, a WTRU may receive (e.g., from a gNB) an indication of a first unified TCI to be used/applied for both a downlink control channel (PDCCH) and a downlink shared channel (PDSCH) (e.g., and/or a downlink RS). The source reference signal(s) in the first unified TCI may provide common QCL information at least for WTRU-dedicated reception on the PDSCH and all (or subset of) CORESETs in a CC. In an example, a WTRU may receive (e.g., from a gNB) an indication of a second unified TCI to be used/applied for both an uplink control channel (PUCCH) and an uplink shared channel (PUSCH) (e.g., and/or an uplink RS). The source reference signal(s) in the second unified TCI may provide a reference for determining common UL TX spatial filter(s) at least for dynamic-grant (DG)/configured-grant (CG) based PUSCH and all (or subset of) dedicated PUCCH resources in a CC.

The WTRU may be configured with a first mode for unified TCI (e.g., SeparateDLULTCI mode, a parameter of ‘unifiedTCIstateType’ set to ‘separate’) where an indicated unified TCI (e.g., the first unified TCI or the second unified TCI) may be applicable for either downlink (e.g., based on the first unified TCI) or uplink (e.g., based on the second unified TCI). In an example, a WTRU may receive (e.g., from a gNB) an indication of a second unified TCI to be used/applied commonly for a PDCCH, a PDSCH, a PUCCH, and a PUSCH (and a DL RS and/or a UL RS).

The WTRU may be configured with a second mode for unified TCI (e.g., JointTCI mode, a parameter of ‘unifiedTClstateType’ set to ‘joint’) where an indicated unified TCI (e.g., the third unified TCI) may be applicable for both downlink and uplink (e.g., based on the third unified TCI).

The WTRU may determine a TCI state applicable to a transmission or reception by first determining a unified TCI state instance applicable to this transmission or reception, then determining a TCI state corresponding to the unified TCI state instance. A transmission may include at least a PUCCH, a PUSCH, and/or a SRS. A reception may include at least a PDCCH, a PDSCH and/or a CSI-RS. A unified TCI state instance may also be referred to TCI state group, TCI state process, unified TCI pool, a group of TCI states, a set of time-domain instances/stamps/slots/symbols, and/or a set of frequency-domain instances/RBs/subbands, etc. A unified TCI state instance may be equivalent or identified to a Coreset Pool identity (e.g., CORESETPoolIndex, a TRP indicator, and/or the like). Hereafter, unified TCI may be interchangeably used with one or more of unified TCI states, unified TCI instance, TCI, and TCI state.

In various embodiments, a WTRU may be configured with a plurality of transmission configuration indicator (TCI) states, e.g., unified TCI (UTCI) states, each applicable for multiple channel(s)/signal(s). The multiple channel(s)/signal(s) may be configured to the WTRU (or pre-determined or defined), e.g., in a form of a list, by a higher-layer signaling (e.g., RRC and/or MAC-CE) which may include at least one of following (e.g., or any combination): One or more control resource sets (CORESETs); one or more PDCCH candidates; one or more search spaces (SSs); one or more PDSCHs (e.g., PDSCH occasions/configurations/instances, etc.); one or more RSs (e.g., CSI-RSs, DMRSs, synchronization signal block (SSB) indexes, position reference signals (PRSs), phase tracking reference signals (PTRSs), and/or sounding reference signals (SRSs)); one or more PUSCHs (e.g., PUSCH occasions/configurations/instances, etc.); one or more PUCCH resources (e.g., PUCCH resource sets/groups); and/or one or more physical random access channel (PRACH) occasions/resources/RSs

In various embodiments, the plurality of TCI states may be configured via RRC signaling (e.g., and/or via a MAC-CE signaling, indication or activation). The WTRU may receive, e.g., via the MAC-CE or a separate signaling, an information content including a mapping between one or more codepoints of a DCI field (e.g., TCI field, and/or TCI selection field) and at least one TCI state of the plurality of TCI states. The WTRU may receive a DCI including the DCI field. The WTRU may be indicated with one or more TCI states, of the plurality of TCI states, mapped to a codepoint of the one or more codepoints of the DCI field. In various embodiments, each of the one or more indicated TCI states is applicable after a time duration, for example, determined based on a beam application time (BAT) parameter.

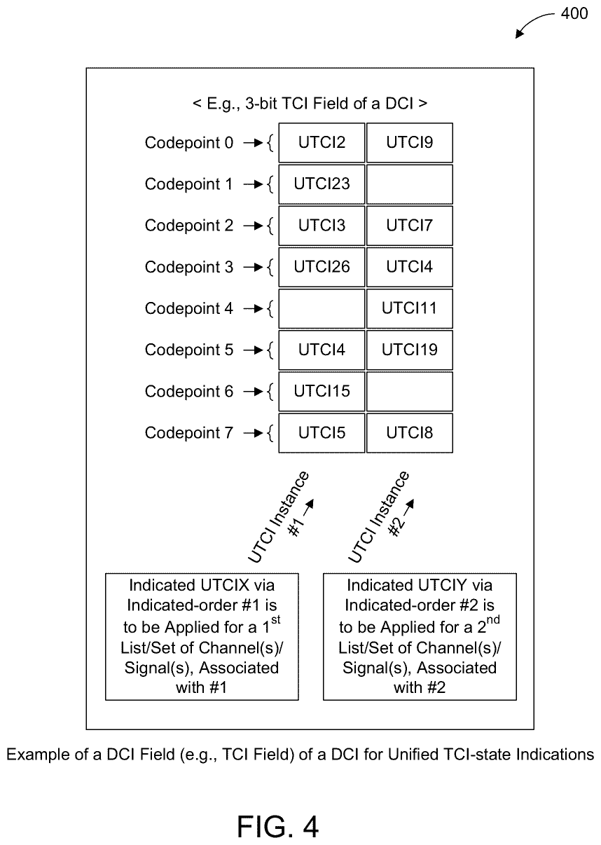

Referring to FIG. 4, an illustrative example of a mapping 400 of the DCI field (e.g., TCI field) of a DCI for unified TCI state indications. The WTRU may receive the mapping 400 between a codepoint (of the DCI field) and one or more TCI states, illustrated in the FIG. 4, e.g., via a MAC-CE signaling. For example, Codepoint 2 is mapped to {UTCI3, UTCI7}, where the WTRU may apply at least one of {UTCI3, UTCI7} to the multiple channel(s)/signal(s), e.g., based on a list of the multiple channel(s)/signal(s) configurable by a higher-layer signaling from a gNB. In an example mapping 400, the list of the multiple channel(s)/signal(s) may be given per UTCI instance (i.e., UTCI instance #1, UTCI instance #2), where the UTCI instance may correspond to each column of the mapping table 400, between a codepoint and the one or more TCI states.

As described herein, a transmission and reception point (TRP) may be interchangeably used with one or more of TP (transmission point), RP (reception point), RRH (radio remote head), DA (distributed antenna), BS (base station), a sector (of a BS), and/or a cell (e.g., a geographical cell area served by a BS). A Multi-TRP may be interchangeably used with one or more of MTRP, M-TRP or and multiple TRPs.

In various examples, a WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as layer 1 reference signal received power (L1-RSRP), signal interference to noise ratio (L1-SINR) taken from a SSB or a CSI-RS (e.g. cri-RSRP, cri-SINR, ssb-Index-RSRP, ssb-Index-SINR), and other channel state information such as rank indicator (RI), channel quality indicator (CQI), precoding matrix indicator (PMI), Layer Index (LI), and/or the like.

Examples of channel and/or interference measurements may include one or more of the following: SSB: A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, cell switching, and so forth.

CSI-RS: A WTRU may measure and report the channel state information (CSI), wherein the CSI for each connection mode may include or be configured with one or more of a CSI report configuration, a CSI-RS resource set and/or a non-zero power (NZP) CSI-RS resources.

Examples of a CSI report configuration may include one or more of: (i) a CSI report quantity, e.g., Channel Quality Indicator (CQI), Rank Indicator (RI), Precoding Matrix Indicator (PMI), CSI-RS Resource Indicator (CRI), Layer Indicator (LI), etc.; (ii) a CSI report type, e.g., aperiodic, semi persistent, periodic; (iii) a CSI report codebook configuration, e.g., Type I, Type II, Type II port selection, etc.; and/or (iv) a CSI report frequency.

Examples of a CSI-RS resource set may include CSI resource settings for one or more of: (i) NZP-CSI-RS Resource for channel measurement; (ii) NZP-CSI-RS Resource for interference measurement; and/or (iii) CSI-IM Resource for interference measurement.

Examples of NZP CSI-RS resources, include one or more of: (i) NZP CSI-RS Resource ID; (ii) periodicity and offset; (iii) QCL Info and TCI state; and/or (iv) resource mapping, e.g., number of ports, density, code division multiplexing (CDM) type, etc.

In various embodiments, a WTRU may indicate, determine, or be configured with one or more reference signals (RSs). The WTRU may monitor, receive, and measure one or more parameters based on the respective reference signals. The following parameters are non-limiting examples of the parameters that may be included in reference signal(s) measurements. One or more of these parameters may be included as well as other parameters.

A synchronization signal reference signal received power (SS-RSRP) may be measured based on the synchronization signals (e.g., demodulation reference signal (DMRS) in PBCH or SSS). It may be defined as the linear average over the power contribution of the resource elements (REs) that carry the respective synchronization signal. In measuring the RSRP, power scaling for the reference signals may be required. In the case SS-RSRP is used for L1-RSRP, the measurement may be accomplished based on CSI reference signals in addition to the synchronization signals.

A channel state information reference signal received power (CSI-RSRP) may be measured based on the linear average over the power contribution of the REs that carry the respective CSI-RS. The CSI-RSRP measurement may be configured within measurement resources for the configured CSI-RS occasions.

A synchronization signal signal-to-noise and interference ratio (SS-SINR) may be measured based on the synchronization signals (e.g., DMRS in PBCH or SSS). It may be defined as the linear average over the power contribution of the REs that carry the respective synchronization signal divided by the linear average of the noise and interference power contribution. In a case that SS-SINR is used for L1-SINR, the noise and interference power measurement may be accomplished based on resources configured by higher layers.

A CSI signal interference to noise ratio (CSI-SINR) may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

A received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth)

A cross-layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth)

A sounding reference signal RSRP (SRS-RSRP) may be measured based on the linear average over the power contribution of the resource elements (RE) that carry the respective SRS.

According to various embodiments, a property of a grant or assignment may include one or more of: a frequency allocation; an aspect of time allocation, such as a duration; a priority; a modulation and coding scheme (MCS); a transport block (TB) size; a number of spatial layers; a number of TBs; a TCI state, CRI or SRI; a number of repetitions; whether the repetition scheme is Type A or Type B; whether the grant is a configured grant (CG) type 1, type 2 or a dynamic grant (DG); whether the assignment is a dynamic assignment or a semi-persistent scheduling (configured) assignment; a configured grant index or a semi-persistent assignment index; a periodicity of a configured grant or assignment; a channel access priority class (CAPC); and/or any parameter provided in a DCI, by MAC or by RRC for the scheduling the grant or assignment.

As used in the described embodiments, an indication by DCI may include one or more of: an explicit indication by a DCI field or by radio network temporary identifier (RNTI) used to mask the cyclical redundancy check (CRC) of the PDCCH; and/or an implicit indication by a property such as DCI format, DCI size, CORESET or search space, aggregation level, first resource element of the received DCI (e.g., index of first control channel element (CCE)), where the mapping between the property and the value may be signaled by RRC or MAC.

Hereafter, a signal may be interchangeably used with one or more of: a sounding reference signal (SRS); a channel state information reference signal (CSI-RS); a demodulation reference signal (DM-RS); a phase tracking reference signal (PT-RS); and/or a synchronization signal block (SSB). In certain examples, a signal may also, or alternatively, mean information sent or received over a control channel or a data channel.

As used herein, a channel may be interchangeably used with one or more of: a physical downlink control channel (PDCCH); a physical downlink shared channel (PDSCH); a physical uplink control channel (PUCCH); a physical uplink shared channel (PUSCH); a physical random access channel (PRACH); and/or any other existing or future type of physical channel. Downlink reception may be used interchangeably with receive (Rx) occasion, a PDCCH, a PDSCH and/or a SSB reception. An uplink transmission may be used interchangeably with transmit (Tx) occasion, a PUCCH, a PUSCH, a PRACH, and/or SRS or other RS transmission. RS may be interchangeably used with one or more of RS resource, RS resource set, RS port and/or RS port group. RS may also be interchangeably used with one or more of SSB, CSI-RS, SRS and/or DM-RS. Time instance may be interchangeably used with slot, symbol and/or subframe

As used herein, UTCI may be interchangeably used with TCI, UTCI state and/or TCI state. UL-only and DL-only Tx/Rx occasions may interchangeably be used with legacy TDD UL or legacy TDD DL, respectively, and still consistent with this disclosure. In an example, the legacy TDD UL/DL Tx/Rx occasions may be the cases where SBFD is not configured and/or where SBFD is disabled, i.e., non-SBFD. The terms received signal power, received signal energy, received signal strength, SSB energy per resource element (EPRE), CSI EPRE, RSRP, RSSI, SINR, reference signal received quality (RSRQ), SS-RSRP, SS-RSSI, SS-SINR, SS-RSRQ, CSI-RSRP, CSI-RSSI, CSI-SINR, and CSI-RSRQ may be used interchangeably. An UL signal (e.g., at least one of a SRS, DMRS, PUSCH, PUCCH, PRACH, PTRS, etc.) may be used interchangeably with a UL signal or channel or a UL channel or signal. A DL signal (e.g., at least one of a CSI-RS, SSB, PDSCH, PDCCH, PBCH, PTRS, etc.) may be used interchangeably with a DL signal or channel or a DL channel or signal.

Embodiments for subband non-overlapping full duplex (SBFD) operations will now be described.

A WTRU may be configured with one or more types of slots within a bandwidth, wherein a first type of slot may be used or determined for a first direction (e.g., downlink or sidelink (e.g., WTRU-to-WTRU communication, device-to-device communication)); a second type of slot may be used or determined for a second direction (e.g., uplink or sidelink); a third type of slot may have a first group of frequency resources within the bandwidth for a first direction and a second group of frequency resources within the bandwidth for a second direction. An illustrative example is shown in FIG. 2

As described in the following embodiments, the term bandwidth may be interchangeably used with bandwidth part (BWP), carrier, subband, and system bandwidth; a first type of slot (e.g., the slot for a first direction) may be referred to as downlink (and/or sidelink) slot; a second type of slot (e.g., slot for a second direction) may be referred to as uplink (and/or sidelink) slot; a third type of slot may be referred to as a subband (non-overlapping or overlapping) full duplex (SBFD) slot, e.g., including at least one of a DL SB(s), an UL SB(s), a sidelink SB(s), a guard band(s) (or RB(s)), and/or flexible SB(s) (e.g., a SB(s) that may be dynamically determined as one of a DL SB(s), an UL SB(s) or a sidelink SB(s));

The group of frequency resources for a first direction may be referred to as downlink (and/or sidelink) subband, downlink (and/or sidelink) frequency resource, or downlink (and/or sidelink) RBs. The group of frequency resources for a second direction may be referred to as an uplink (and/or sidelink) subband, an uplink (and/or sidelink) frequency resource, or uplink (and/or sidelink) RBs. The group of frequency resources for a flexible direction (e.g., one that can be configured for a first direction, second direction, etc.) may be referred to as a flexible subband, a flexible frequency resource, or flexible RBs. The group of frequency resources between a first direction and a second direction may be referred to as a guard band, guard frequency resource, or guard RBs.

In various embodiments, a (SBFD-enabled) WTRU may receive configuration information or be configured with one or more SBFD UL, DL, sidelink, flexible, and/or guard subbands in one or more DL/UL/flexible TDD time instances (e.g., symbols, slots, frames, and so forth). The WTRU may be configured with one or more resource allocations for SBFD subbands. In certain examples, the SBFD configuration may include a flag signal (e.g., enabled/disabled). The flag signal may have a first value (e.g., zero (0)) which may indicate a first mode of operation (e.g., SBFD configuration), and a second value (e.g., one (1)) which may indicate a second mode of operation (e.g., non-SBFD operation). The modes of operation (e.g., SBFD and/or non-SBFD) may be indicated for the WTRU, for example via a master information block (MIB), a system information block (SIB), RRC, MAC-CE, DCI or related processes.

The WTRU may receive the time resources (e.g., one or more symbols, slots, etc.), for which the first mode of operation (e.g., SBFD) is defined in, for example, one or more BWPs, subbands, component carriers (CC), cells, and so forth. The WTRU may receive the frequency resources (e.g., subbands/BWPs including one or more physical resource blocks (PRBs) within (active and/or linked) BWP, for which the first mode of operation (e.g., SBFD) is configured. The time instances (e.g., slots, symbols) may be indicated based on periodic, semi-persistent, or aperiodic type configurations. In an example, the time instances may be indicated via a bitmap configuration, where each bit corresponds to a time instance (e.g., slot, symbol, subframe, etc.) and each bit indication indicates whether a corresponding time instance can be used for the first or second mode of operation.

In one example, a WTRU may be configured with a DL TDD configuration for a component carrier (CC) or a BWP for one or more Rx occasions (e.g., via tdd-UL-DL-config-common, dedicated configurations or slot format indicator (SFI), etc.). As such, if the first mode of operation (e.g., SBFD) is configured, one or more of the configured frequency resources (e.g., subbands, PRBs, and/or BWPs) may be configured for the transmission in UL channels and/or Tx occasions.

In another example, the WTRU may be configured with an UL TDD configuration for a component carrier (CC) or a BWP for one or more Tx occasions (e.g., via tdd-UL-DL-config-common, dedicated configurations or slot format indicator (SFI). As such, if the first mode of operation (e.g., SBFD) is configured, one or more of the configured frequency resources (e.g., subbands, PRBs, and/or BWPs) may be configured as the DL channels and/or Rx occasions.

In another example, the WTRU may be configured with a DL, UL, or Flexible TDD configuration for a component carrier (CC) or a BWP for one or more Rx/Tx occasions (e.g., via tdd-UL-DL-config-common, dedicated configurations or slot format indicator (SFI). As such, if the first mode of operation (e.g., SBFD) is configured, one or more of the configured frequency resources (e.g., subbands, PRBs, and/or BWPs) may be configured for the first mode of operation (e.g., either UL transmission or DL reception based on the configurations).

The duplexing mode for the first mode of operation (e.g., SBFD configuration (UL/DL)) may be indicated via a flag indication, where for example a first value (e.g., zero (0)) may indicate a first direction (e.g., UL duplexing mode), and a second the value (e.g., one (1)) may indicate a second direction (e.g., DL duplexing model).

The duplexing mode configuration and/or flag for the first mode of operation (e.g., SBFD) may be configured as part of modes of operation configuration, for example via MIB, SIB, RRC, DCI, MAC-CE, etc.

The duplexing mode configuration and/or flag for the first mode of operation (e.g., SBFD) may be configured as part of resource allocation configuration for a Tx/Rx occasion.

In an example, a WTRU may be configured with one or more types of slots. The WTRU may be configured with a first slot with a first type, where the first type may be for example SBFD slot. The WTRU may be configured with a second slot with a second type, where the second type may be for example non-SBFD slot. As for the first slot with the first type (SBFD), the WTRU may be configured with one or more DL, UL, flexible, guard, etc. subbands in the frequency domain, throughout the BWP, for the duration of the first slot. However, in the second slot with the second type (non-SBFD), the WTRU may be configured with only one direction type, for example DL, UL, flexible, etc., in the frequency domain, throughout the BWP, for the duration of the second slot.

In another example, if the WTRU is configured with a second slot with UL direction, this implies legacy TDD UL slot, UL-only slot, and/or non-SBFD UL slot. In another example, if the WTRU is configured with a third slot with second type (non-SBFD) with DL direction, this implies legacy TDD DL slot, DL-only slot, and/or non-SBFD DL slot. In another example, if the WTRU is configured with a fourth slot with second type (non-SBFD) with flexible direction, this implies legacy TDD flexible slot and/or non-SBFD flexible slot, and so forth.

Examples of SBFD time-domain configuration are described. In certain embodiments, a WTRU may receive configurations of (e.g., may be configured with) SBFD subband time locations that may be configured within a period. In an example, the period may be the same as TDD-UL-DL pattern period configured by dl-UL-TransmissionPeriodicity, e.g., in TDD-UL-DL-ConfigCommon. In an another example, the period may be an integer multiple of a TDD-UL-DL pattern period configured by dl-UL-TransmissionPeriodicity, e.g., in TDD-UL-DL-ConfigCommon.

When for example, only one TDD-UL-DL pattern is configured, SBFD symbols may be configured in a consecutive manner within a TDD-UL-DL pattern period. When two TDD-UL-DL patterns are configured and if SBFD symbols are configured for only one of the patterns, SBFD symbols may be configured in consecutive manner within the TDD-UL-DL pattern period. When two TDD-UL-DL patterns are configured and if SBFD symbols are configured for both patterns, SBFD symbols may be configured in consecutive manner within each TDD-UL-DL pattern period.

Usable PRBs of embodiments are described. A WTRU may determine (or be indicated/configured with) that ‘UL usable PRBs’ are a part of UL subband frequency resources within an UL BWP (e.g., an active UL BWP, a currently active UL BWP), and ‘DL usable PRBs’ are a part of DL subband frequency resources within an DL BWP (e.g., an active DL BWP, a currently active DL BWP). The UL usable PRBs may be determined as an intersection between a configured or indicated UL subband and an active UL BWP in SBFD symbols (and/or slots). The DL usable PRBs may be determined as an intersection between a configured or indicated DL subband(s) and an active DL BWP in SBFD symbols (and/or slots). In an (e.g., another) example, the UL and/or DL usable PRBs may be explicitly configured within active UL and/or DL BWP, e.g., in SBFD symbols and/or slots.

In one embodiment, a WTRU may receive information on frequency resource allocation (e.g., Type 0 as resource block group (RBG)-level bitmap-based resource assignment) for a PDSCH or PUSCH (as being scheduled) in a slot(s). When an assigned RBG overlaps with a subband boundary, the WTRU may determine that (only) the PRBs within the DL usable PRBs are to be valid for PDSCH reception and (only) the PRBs within the UL usable PRBs are to be valid for PUSCH transmission, e.g., where this may imply “partial RBG” is allowed and valid for resource allocation.

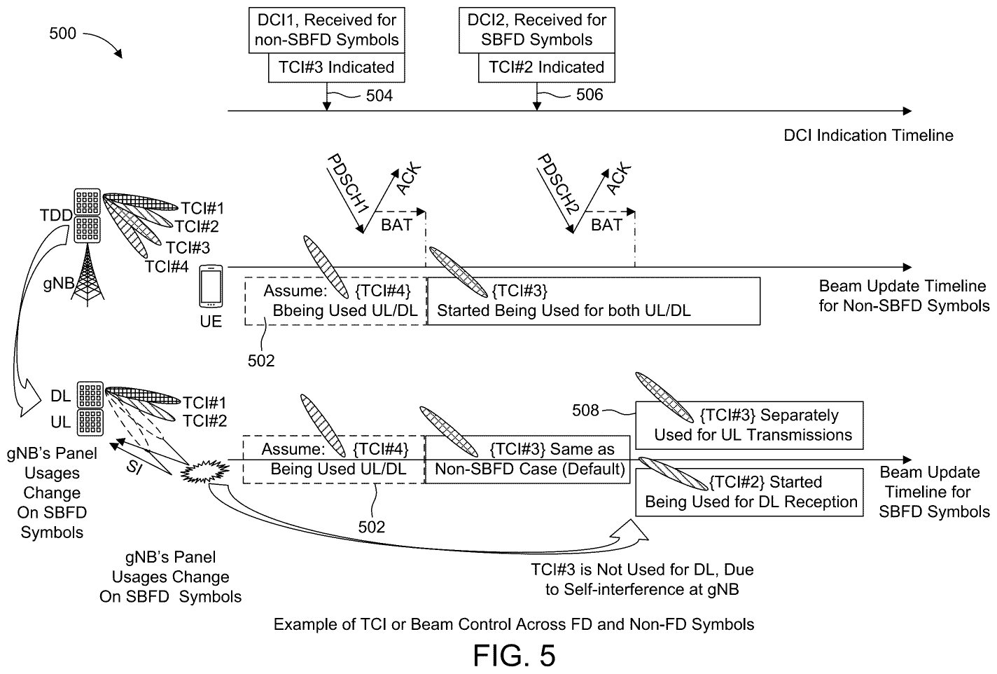

Referring to FIG. 5, an example framework 500 for a WTRU to implicitly determine a mapping between an indicated TCI state codepoint and a full duplex (FD) symbol type (e.g., SBFD or non-SBFD) is shown.

Initially, a WTRU receives SBFD-related configuration information and a plurality of TCI states (e.g., an RRC-configured pool of TCI states). A TCI-activation command (e.g., via a MAC-CE) is sent from the base station, e.g., gNB, to the WTRU indicating an activated set of TCI states (e.g., TCI #1, TCI #2, TCI #3, TCI #4) among the plurality of configured TCI states.

In diagram 500, although not required, the WTRU shown using an initial TCI state 502 (i.e., TCI #4) for uplink (UL) and/or downlink (DL) transmissions. At point 504, the gNB sends, and the WTRU receives, a first DCI (i.e., DCI1), indicating a next TCI state (i.e., TCI #3), among the activated set of TCI states. The WTRU determines that the reception of DCI1 or the indicated TCI state is for non-SBFD symbols, e.g., in terms of TCI/beam update, and the WTRU associates the indicated TCI state (i.e., TCI #3) with non-SBFD symbols for UL transmissions and/or DL receptions.

In an diagram 500, (e.g., by default), until a SBFD-specific TCI control command is received, the WTRU uses the TCI state (i.e., TCI #3) indicated by the first DCI (i.e., DCI1) is also associated with SBFD symbols, e.g., for UL transmissions and/or DL receptions.

Next, the WTRU transmits a first UL channel or signal (e.g., PUSCH, PUCCH, SRS) using the first DCI indicated TCI state (i.e., TCI #3), and/or receives a first DL channel or signal (e.g., PDSCH, PDCCH, CSI-RS) using the first DCI indicated TCI state (i.e., TCI #3).

At point 506, the gNB sends and the WTRU receives, a second DCI (DCI2) indicating a next TCI state (i.e., TCI #2), among the activated set of TCI states. The WTRU determines that the reception of DCI2 or the second DCI indicated TCI state is for with SBFD symbols, e.g., in terms of TCI/beam update. In this case, DCI2 may be referred to as a SBFD-specific TCI control command.

Based on the determination, the WTRU associates the second DCI indicated TCI state with SBFD symbols for DL receptions to the second TCI state (i.e., TCI #2). At point 508, the WTRU continues to use the first DCI indicated TCI state (i.e., TCI #3) in association with SBFD symbols for UL transmissions. At point 508, the WTRU also continues to use the first DCI indicated TCI state (i.e., TCI #3) in association with non-SBFD symbols, e.g., for UL transmissions and/or DL receptions.

In various embodiments, the WTRU does one or more of the following: the WTRU transmits a second UL channel or signal using the first DCI indicates TCI state (i.e., TCI #3) on SBFD symbol(s) and/or non-SBFD symbol(s); the WTRU receives a second DL channel or signal using the second DCI indicated TCI state (i.e., TCI #2) on SBFD symbol(s); and/or the WTRU receives a third DL channel or signal by using the first DCI indicated TCI state (i.e., TCI #3) on non-SBFD symbol(s).

In certain embodiments, the WTRU may determine that a DCI (e.g., DCI1 or DCI2) or the TCI state indicated by the DCI (e.g., the first DCI indicated TCI state or the second DCI indicated TCI state) is associated with non-SBFD symbols (e.g., for UL and/or DL) or SBFD symbols (e.g., for UL and/or DL) based on at least one, or any combination, of the following:
The symbol type (SBFD or non-SBFD) in which the DCI (i.e., DCI1 or DCI2) is received;
An identity or type of CORESET, CORESET pool, search space, search space group in which the DCI is received;
A reception timing of the DCI or a time offset from the reception time of the DCI;
The SBFD configuration and/or an explicit indication; and/or
The DCI type (e.g., DCI format, DCI size).

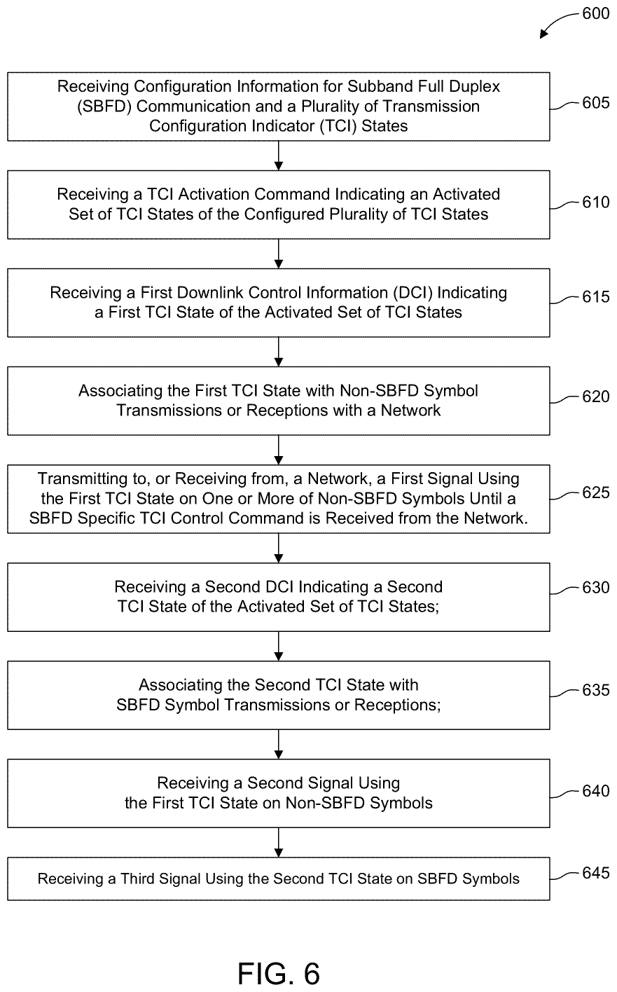

Referring to FIG. 6, a method 600 for a WTRU to perform transmissions and/or receptions using non-SBFD symbols and SBFD symbols based on an indicated associated TCI state is shown. Initially, the WTRU may receive 605 a configuration including information for subband full duplex (SBFD) communication and a plurality of transmission configuration indicator (TCI) states. The WTRU may receive 610 a TCI activation command indicating an activated set of TCI states of the configured plurality of TCI states.

The WTRU receives 615 a first downlink control information (DCI) indicating a first TCI state of the activated set of TCI states and associates 620 the first TCI state with non-SBFD symbol transmissions and/or receptions with a network based on any of the determination methods disclosed herein. The WTRU then sends or receives 625 signals with the network using the first activated TCI state for one or more of non-SBFD, and optionally also SBFD symbols, until a SBFD-specific TCI control command is received from the network.

The WTRU may receive 630 a second DCI indicating a second TCI state of the activated set of TCI states and associates 635 the second TCI state with SBFD symbol transmissions and/or receptions based on any of the determination techniques described herein. Receipt of the second DCI may be referred to as a SBFD-specific TCI control command. The WTRU may then receive or send 640 a second signal/channel using the first TCI state on non-SBFD symbols and receive or send 645 a third signal/channel using the second TCI state on SBFD symbols. Method 600 may be varied based on any one or combination of the various embodiments described in this disclosure.

In various embodiments, the SBFD symbols may include subband-non-overlapping SBFD symbols including one or more SBFD subbands and the non-SBFD symbols may include time division duplex (TDD) symbols without SBFD subbands.

In various embodiments, the first, second or third signals may include any one of a control channel, a data channel or a reference signal. In various embodiments, the WTRU associates 620 the first TCI state with non-SBFD symbol transmissions or receptions based on a determination of one of: a symbol type in which the first DCI is received, an identify or type of CORSET, a search space and search space set in which the first DCI is received, a reception timing of the first DCI or time offset from the reception time of the first DCI, the configuration information for SBFD communication, an explicit indication from the network, or a DCI type of the first DCI.

According to various embodiments, the WTRU associates 635 the second TCI state with SBFD symbol transmissions or receptions based on a determination one of: a symbol type in which the second DCI is received, an identify or type of CORSET, a search space and search space set in which the second DCI is received, a reception timing of the second DCI or time offset from the reception time of the second DCI, the configuration information for SBFD communication, an explicit indication from the network, or a DCI type of the second DCI.

In some embodiments, the first TCI state is a unified TCI (UTCI) state for transmitting or receiving a signal on either or both of SBFD or non-SBFD symbols. In various examples, the configuration information includes a mapping between one or more codepoints of a DCI field and one or more TCI states of the plurality of TCI states as described herein. According to some embodiments, the first DCI and the second DCI includes the DCI field, and each of the one or more TCI states is applicable after a time duration based on a beam application time (BAT) parameter.

WTRU configuration aspects are now described. In various embodiments, a WTRU may receive configurations (e.g., from a gNB, a node, or a device) for full-duplex (FD) operation conducted by at least one device in a network. In an example, the FD operation may be conducted by a gNB (e.g., a BS, a node, a TRP, a cell). The WTRU may operate in a half-duplex (HD) mode for communicating with the gNB, where the HD mode may imply at a given time the WTRU either performs a UL transmission or a DL reception (but not both simultaneously at the given time). The WTRU may (also) operate in an FD mode for communicating with the gNB, e.g., if a corresponding WTRU capability signal(s) is reported to the gNB and/or the WTRU receives a confirmation signal (e.g., enabling the FD, configuring the FD mode) in response to transmitting the WTRU capability signal(s).

The FD operation may imply at a given time a transmitter (e.g., the gNB and/or the WTRU) may simultaneously transmit a first signal and receive a second signal. The FD operation may include a subband overlapping FD (e.g., in-band FD (IBFD) operation where a first frequency-domain resource (e.g., RBG(s), RB(s), RE(s) is allocated for the first signal may have a full (or at least a partial) overlap with a second frequency-domain resource allocated for the second signal. The FD operation may include a subband non-overlapping FD (SBFD) operation where a first frequency-domain resource allocated for the first signal (e.g., assigned within a configured SBFD subband, e.g., DL subband, usable DL PRBs) does not have an overlap with a second frequency-domain resource allocated for the second signal (e.g., assigned within a configured SBFD subband, e.g., UL subband, usable UL PRBs).

Hereafter, for the brevity of discussion, the FD operation may comprise the SBFD operation, however the described solutions and processes may equally (or equivalently or extendedly, etc.) be employed for cases with other FD operation types (e.g., IBFD, etc.).

A WTRU may receive SBFD-related configuration(s), e.g., for frequency-domain location information of one or more subbands (e.g., DL subband, UL subband, flexible DL/UL subband, and/or guardband), and/or for time-domain location information of the one or more subbands. The time-domain location information may indicate a set of non-SBFD symbols and a set of SBFD symbols (e.g., as illustrated in FIG. 2). A symbol(s) within the set of non-SBFD symbols may be a type of ‘DL symbol’, ‘UL symbol’ or ‘flexible symbol’. The WTRU may receive a DL signal on symbol(s) based on a type of ‘DL symbol’ in the set of non-SBFD symbols. The WTRU may transmit a UL signal on symbol(s) based on a type of ‘UL symbol’ in the set of non-SBFD symbols. The WTRU may either receive a DL signal or transmit a UL signal on symbol(s) based on a type of ‘flexible symbol’ in the set of non-SBFD symbols, e.g., depending on one or more conditions with other signal(s) co-existing in the symbol(s).

In various embodiments, the WTRU may receive transmit configuration indication (TCI) related configuration(s), e.g., including a plurality of TCI states (e.g., an RRC-configured pool of TCI states (e.g., as unified TCI framework), ‘TC/state’ information element (IE), ‘TCI-UL-State’ IE, ‘spatialRelationInfo’ IE, etc.).

Example activation of TCI states and/or beam references will now be described. The WTRU may receive a TCI-activation command (e.g., via a MAC-CE) indicating (e.g., activating, updating, etc.) an activated set of TCI states (e.g., TCI #1, TCI #2, TCI #3, TCI #4 in FIG. 5) among the plurality of TCI states. In one example, the WTRU may maintain (e.g., track, keep tracking) one or more quasi co-location (QCL) properties based on RSs within the activated set of TCI states, where the one or more QCL properties may include at least one of average delay, Doppler shift, delay spread, Doppler spread, spatial Rx, and/or average power, e.g., upon receiving the TCI-activation command. In an example, the WTRU may not maintain (e.g., track) the QCL properties for an RS of a TCI state (among the plurality of TCI states) that is not activated by the TCI-activation command. The activated set of TCI states may be ready for use for a transmission or a reception when scheduled.

Embodiments for dynamic selection of TCI state (or beam reference) for different symbol types (e.g., SBFD, non-SBFD) are disclosed. In one embodiment, with reference to FIG. 5, the WTRU may receive a first DCI (e.g., FIG. 5 DCI1) scheduling a first PDSCH (i.e., PDSCH1) (or without scheduling a PDSCH) and indicating a first TCI state (e.g., TCI #3) among the activated set of TCI states. The WTRU may receive (e.g., decode, demodulate) the first PDSCH using TCI #X (e.g., X=4) that is a previously indicated initial TCI state (e.g., at 502 in FIG. 5), which may or may not be the same as the indicated TCI #3. In response to receiving the first PDSCH (e.g., using TCI #4), the WTRU may transmit an ACK (to a gNB) indicating a successful reception of the first PDSCH and/or a successful reception of the DCI indicated first TCI state (TCI #3). The WTRU may (be configured to) start to apply the indicated first TCI state (TCI #3) at a time, e.g., T_BAT after transmitting the ACK, where a value of a beam application time (BAT), e.g., the T_BAT, may be configured by the gNB. Until further receiving a second indicated TCI state (e.g., by DCI2), the WTRU may maintain (e.g., in terms of the QCL properties) the indicated first TCI state (TCI #3) for use of communications (for UL transmissions and/or DL receptions) with the gNB.

In one embodiment, the WTRU may determine that the reception of DCI1 or the first TCI state (TCI #3) is associated with non-SBFD symbols, e.g., in terms of TCI/beam update. The determination may be based on an explicit indication from a gNB and/or based on an implicit rule, e.g., on condition of the symbol(s) where the DCI1 is received, which CORESET (and/or search space) the DCI1 is received, which RNTI the detected DCI1 is scrambled with, and so forth. Based on determining that the reception of DCI1 or the first TCI state (TCI #3) is associated with non-SBFD symbols, the WTRU may update the indicated first TCI state (TCI #3) for UL transmissions and/or DL receptions, e.g., at least for non-SBFD symbols, or for both non-SBFD symbols and SBFD symbols, until a SBFD-specific TCI control command is received. In an example (e.g., by default), until (e.g., unless) a SBFD-specific TCI control command is received, the WTRU may use the DCI indicated first TCI state (TCI #3) also in association with SBFD symbols, e.g., for UL transmissions and/or DL receptions. In an example, the WTRU may transmit a first UL channel or signal (e.g., PUSCH, PUCCH, SRS) using the indicated first TCI state (TCI #3), and/or receive a first DL channel or signal (e.g., PDSCH, PDCCH, CSI-RS) using the indicated first TCI state (TCI #3).

The WTRU may receive a second DCI (DCI2) at point 506 scheduling a second PDSCH (i.e., PDSCH2) (or without scheduling a PDSCH) and indicating a second TCI state (e.g., TCI #2) among the activated set of TCI states. The WTRU may receive (e.g., decode, demodulate) the second PDSCH using a previously indicated TCI state (which is TCI #3 indicated by the DCI1). In response to receiving the second PDSCH (using TCI #3), the WTRU may transmit an ACK (to a gNB) indicating a successful reception of the second PDSCH and/or a successful reception of the indicated first TCI state (TCI #2). The WTRU may (be configured to) start to apply the DCI indicated second TCI state (TCI #2) for at least one communication direction (e.g., DL), T_BAT2 after transmitting the ACK, where a BAT of T_BAT2 may be configured by the gNB and may be same as or independent from the T_BAT.

In example embodiments, the WTRU may determine that the reception of DCI2 or the indicated second TCI state (TCI #2) is associated with SBFD symbols, e.g., in terms of TCI/beam update, where the reception of the DCI2 may correspond to the SBFD-specific TCI control command. The determination of SBFD symbol association with DCI2 may be based on an explicit indication from a gNB and/or based on an implicit rule, e.g., on condition of the symbol(s) where the DCI2 is received, which CORESET (and/or search space) the DCI2 is received on, which RNTI the detected DCI2 is scrambled with, and so forth. Based on determining that the reception of DCI2 or the second TCI state (TCI #2) is for SBFD symbols, the WTRU may associate the indicated second TCI state (TCI #2) for one communication direction (e.g., either UL transmission, or DL reception), where the one communication direction the WTRU applies for may be (pre-) configured or (separately) indicated by the gNB. As an example, based on determining that the reception of DCI2 or the second TCI state (TCI #2) is associated with SBFD symbols, at point 508 of FIG. 5, the WTRU may use the indicated second TCI state (TCI #2) for DL receptions (e.g., on condition that the one communication direction is configured or indicated as a DL direction), e.g., while the WTRU may continue to use the first TCI state (TCI #3) in association with SBFD symbols for UL transmissions. In one example, the WTRU may continue to use the first TCI state (TCI #3) in association with non-SBFD symbols, e.g., for UL transmissions and/or DL receptions.

In various embodiments, a TCI state (e.g., indicated second TCI state) may be associated with SBFD symbols based on at least one of the following:
When one or more symbols are involved for a transmission or a reception, only SBFD symbols among the symbols are associated with the TCI state;
When the number of SBFD symbols within the symbols involved for a transmission or a reception is equal to or larger than a threshold, all the symbols (both SBFD and non-SBFD symbols) involved for the transmission/reception are associated with the TCI state. As an example, the threshold may be proportional to the number of symbols involved for the transmission/reception (e.g., X %), configured via higher layer signaling, dynamically indicated in the associated DCI, or pre-defined; and/or
When all the symbols involved for a transmission or a reception are SBFD symbols, the symbols are associated with the TCI state.

As used herein, a non-SFBD symbol may be interchangeably used with a first time/frequency resource type and a SFBD symbol may be interchangeably used with a second time/frequency resource type. Examples of one or more of following may apply:

A first time/frequency resource type may be a resource wherein all resources used for the same direction (e.g., UL, DL) and a second time/frequency resource type may be a resource wherein a first portion of the resource may be used for one direction (e.g. DL or UL) and a second portion of the resource may be used for another direction (e.g., UL or DL).

Alternatively, a time/frequency resource type may be determined based on one or more of: Interface type (e.g., Uu, SL, TN, NTN) associated with the resource; data traffic type (e.g., enhanced mobile broadband (eMBB), ultra-reliable low latency communications (URLLC), massive machine-type communications (mMTC), communication, sensing) associated with the resource; transmission type (e.g., single TRP, multiple TRPs, simultaneous transmission across multi-panel (STxMP), etc.) associated with the resource; frequency band (e.g., FR1, FR2, FR3) associated with the resource; numerologies (e.g., subcarrier spacing, cyclic prefix (CP) length, etc.); waveform used (e.g., OFDM, DFT-s-OFDM); and/or DMRS configurations (e.g., Type-1 DMRS, Type-2 DMRS, DMRS density).

In one example solution, based on determining that the reception of DCI2 or the second TCI state (TCI #2) is associated with SBFD symbols, the WTRU may update the indicated second TCI state (TCI #2) for (e.g., either or both) UL transmissions and/or DL receptions which the WTRU performs using SBFD symbol(s), while the WTRU may continue to use the first TCI state (TCI #3) in association with non-SBFD symbols, e.g., for UL transmissions and/or DL receptions.

Based on receiving the SBFD-specific TCI control command (e.g., the DCI2 in FIG. 5), the WTRU may transmit a second UL channel or signal using the first TCI state (TCI #3) on SBFD symbol(s) and/or non-SBFD symbol(s). The WTRU may receive a second DL channel or signal using the second TCI state (TCI #2) on SBFD symbol(s), while the WTRU may receive a third DL channel or signal by using the first TCI state (TCI #3) on non-SBFD symbol(s). This may provide benefits in terms of improving reliability in one communication direction performance (e.g., UL performance) while maintaining an optimized performance for another (e.g., the other) communication direction, e.g., in FIG. 5 when the gNB transmits a DL signal from a first gNB panel and simultaneously receives a UL signal at a second gNB panel, and some of DL beams (TCIs) (e.g., TCI #3, TCI #4) cause a self-interference (SI) on the UL reception, e.g., due to signal reflection, diffraction, by a clutter, obstacle, or by a non-ideal spatial-separation between the first and second gNB panels, etc.

In certain embodiments there may be restriction on an activated set of TCI states for SBFD symbols. In a solution, a WTRU may be indicated or configured with restriction on a subset of an activated set of TCI states for SBFD symbols. For example, when 8 TCI states are activated (e.g., via MAC-CE) for dynamic indication of TCI state for DL reception/UL transmission for non-SBFD symbol, a WTRU may be also indicated which subset of activated TCI states are restricted for DL reception/UL transmission for SBFD symbols. When the indicated TCI state is within the restricted TCI states, one or more of following may apply to transmit or receive on SBFD symbols:

(1) An alternate TCI state may be indicated/configured for each of the restricted TCI states and the alternate TCI state may be applied for SBFD symbol(s). In one example, the alternate TCI state may be one of the non-restricted set of the activated TCI states or one of the TCI states configured but not activated.

(2) A fallback or default TCI state may be defined (or configured) and used for the SBFD symbols (e.g., lowest TCI state index within the non-restricted set of the activated TCI states, or configured via a higher layer signaling, or a TCI state(s) associated with a (e.g., lowest-ID) CORESET, or a TCI state(s) associated with a (e.g., lowest-ID) CORESET that is associated with SBFD symbol(s) or a SBFD symbol type, or a TCI state(s) associated with a (e.g., lowest-ID) CORESET where a search space (set) linked to the CORESET may be associated with SBFD symbol(s) or a SBFD symbol type).

Examples on related WTRU behaviors are described. In one embodiment, the WTRU may (e.g., separately) receive information, e.g., from a gNB, on a first set of TCI states, when used as DL TCI information (e.g., beam), that may cause self-interference (SI) to UL reception at gNB, e.g., where the first set of TCI states may represent “forbidden DL beams”. The first set of TCI states (e.g., TCI #3, TCI #4 in FIG. 5) may be a subset of the activated set of TCI states (e.g., TCI #1, TCI #2, TCI #3, TCI #4). The WTRU may receive the information on the first set of TCI states via a TCI-activation command (e.g., via a MAC-CE, via the (same) MAC-CE TCI-activation command that updates the activated set of TCI states).

When a DCI indicated TCI state (e.g., DCI1, DCI2 of FIG. 5), is not comprised in the first set of TCI states and is comprised in the activated set of TCI states, the WTRU (commonly) uses the indicated TCI state (TCI #1, TCI #2, e.g., transmitted from (gNB's) DL panel) on non-SBFD symbols and SBFD symbols, e.g., for UL transmissions and/or DL receptions. When a DCI indicated TCI state (e.g., DCI1, DCI2), is included in the first set of TCI states, the WTRU may (separately) use a first TCI state for UL transmissions and a second TCI state for DL receptions, where the first TCI state (e.g., TCI #3), for UL transmissions (e.g., on SBFD symbols), may be one in the first set of TCI states, or may be indicated separately, or may be pre-associated (e.g., by RRC and/or MAC-CE) with the second TCI state. The second TCI state (e.g., TCI #2), for DL receptions (e.g., on SBFD symbols), may not be included in the first set of TCI states (e.g., but included in the activated set of TCI states), or may be indicated separately.

Examples are now described to determine the indicated TCI is associated with a particular symbol type (e.g., SBFD or non-SBFD). In various embodiments, the WTRU may determine that a DCI (e.g., DCI1 or DCI2 of FIG. 5) or the TCI state indicated by the DCI (e.g., the indicated first TCI state or the second TCI state) is associated with non-SBFD symbols (e.g., for UL and/or DL) or SBFD symbols (e.g., for UL and/or DL) may be based on or more of: the symbol type (SBFD or non-SBFD) in which the DCI (DCI1 or DCI2) is received; a reception timing of the DCI or a time offset from the reception time of the DCI; a CORESET or search space in which the DCI is received; a RNTI of the DCI; and/or the SBFD configuration and/or an explicit indication

According to a first example, determination of the symbol type (SBFD or non-SBFD) for a TCI state may be based on the symbol type for which the DCI (DCI1 or DCI2) is received. In one embodiment, the WTRU may determine that the DCI indicated TCI state is associated with a non-SBFD symbol type, on condition that the DCI is received in non-SBFD symbol(s) (or in a first set of symbol indexes within a TDD and/or SBFD pattern period(s)), where the WTRU may update the indicated TCI state for UL transmissions and/or DL receptions for (at least) one symbol type, e.g., for non-SBFD symbols only, while the WTRU may continue to use a TCI state indicated by the most-recent SBFD-specific TCI control command on SBFD symbols, e.g., on condition that the DCI is received within Y slots or symbols after receiving the most-recent SBFD-specific TCI control command. In one example, the WTRU may receive an indication or configuration for the first set of symbol indexes (e.g., configured as the first N symbols within a period, including 1st, 2nd, 3rd symbols (e.g., N=3) within a configured TDD pattern period(s) and/or a configured SBFD time-domain pattern period, e.g., illustrated in FIG. 2). This may provide benefits in that gNB may be able to adjust the ratio of the first set of symbol indexes and other (remaining) symbol indexes within the TDD and/or SBFD pattern period(s), which provides flexibility on TCI/beam control for different symbol types.

In another example, the WTRU may update the DCI indicated TCI state for UL transmissions and/or DL receptions for both non-SBFD symbols and SBFD symbols unless a SBFD-specific TCI control command is received within a time duration or period that may be configured or determined based on a rule in association with at least the reception timing of the DCI. In an example, on condition that the DCI is received at least Y slots or symbols after receiving the most-recent SBFD-specific TCI control command and/or no SBFD-specific TCI control command has been received so far (e.g., after the most-recent TCI-activation command is received via a MAC-CE), the WTRU may update the indicated TCI state for UL transmissions and/or DL receptions for both non-SBFD symbols and SBFD symbols. This may provide benefits in terms of improving robustness and efficiency of TCI control by performing or applying a TCI fallback to a common TCI control regardless of the symbol type (e.g., either SBFD or non-SBFD) based on such condition.

In one example solution, the WTRU may determine that the DCI indicated TCI state is associated with a SBFD symbol type, on condition that the DCI is received in SBFD symbol(s) (or in symbol(s) not belonging to the first set of symbol indexes), where the WTRU may associate the indicated TCI state for one communication direction (e.g., either UL transmission, or DL reception), where the one communication direction the WTRU applies for may be (pre-) configured or (separately) indicated by the gNB. In an example, the WTRU may update the indicated TCI state for DL receptions (e.g., on condition that the one communication direction is configured or indicated as a DL direction), while the WTRU may continue to use a previously indicated TCI state in association with SBFD symbols for UL transmissions.

In a second example, determination of an associated SBFD or non-SBFD symbol type may be based on a reception timing of the DCI or a time offset from the reception time of the DCI. In one embodiment, the WTRU may determine that the DCI indicated TCI state is associated with a non-SBFD symbol type, on condition that a symbol after a time offset from the reception time of the DCI is determined as a non-SBFD symbol. The WTRU may associate the indicated TCI state for UL transmissions and/or DL receptions for (at least) one symbol type, e.g., for non-SBFD symbols only, while the WTRU may continue to use a TCI state indicated by the most-recent SBFD-specific TCI control command on SBFD symbols, e.g., on condition that the DCI is received within Y slots or symbols after receiving the most-recent SBFD-specific TCI control command. The time offset may be (separately) configured or indicated to the WTRU, or determined based on (e.g., in association with) a beam application time (BAT), e.g., T_BAT. In an example, the time offset may be in association with a PDSCH reception timing where the PDSCH is scheduled by the DCI. For example, the WTRU may determine that the DCI indicated TCI state is associated with a non-SBFD symbol type, on condition that a first symbol of a PDSCH scheduled by the DCI is (e.g., determined as) a non-SBFD symbol. This may provide benefits in that a “cross-symbol-type” beam update may be enabled or achieved, to reliably update a first beam for a first symbol type by receiving the DCI on symbol(s) of a second symbol type (if the symbol after the time offset turns to be the first symbol type), e.g., when a beam (or channel) quality of the first symbol type is low.

In another example, the WTRU may associate the indicated TCI state for UL transmissions and/or DL receptions for both non-SBFD symbols and SBFD symbols unless a SBFD-specific TCI control command is received within a time duration or period that may be configured or determined based on a rule in association with the symbol after a time offset from the reception time of the DCI. In an example, on condition that the symbol is determined (e.g., appeared, identified) at least Y slots or symbols after receiving the most-recent SBFD-specific TCI control command and/or no SBFD-specific TCI control command has been received so far (e.g., after the most-recent TCI-activation command is received via a MAC-CE), the WTRU may associate the DCI indicated TCI state for UL transmissions and/or DL receptions for both non-SBFD symbols and SBFD symbols.

In one example, the WTRU may determine that the indicated TCI state (e.g., by the DCI) is associated with a SBFD symbol type, on condition that the symbol after the time offset from the reception time of the DCI is determined as an SBFD symbol, where the WTRU may update the indicated TCI state for one communication direction (e.g., either UL transmission, or DL reception). The one communication direction the WTRU applies may be (pre-) configured or (separately) indicated by the gNB. In an example, the WTRU may associate the indicated TCI state for DL receptions (e.g., on condition that the one communication direction is configured or indicated as a DL direction), while the WTRU may continue to use a previously indicated TCI state in association with SBFD symbols for UL transmissions.

In a third example, determination of an associated SBFD or non-SBFD symbol type is based on a CORESET or search space in which the DCI is received. In one embodiment, the WTRU may determine that the indicated TCI state (e.g., by the DCI) is associated with a non-SBFD symbol type, on condition that the DCI is received via a first CORESET index and/or a first search space index. In that case, the WTRU may associate the indicated TCI state for UL transmissions and/or DL receptions for (at least) one symbol type, e.g., for non-SBFD symbols only, while the WTRU may continue to use a TCI state indicated by the most-recent SBFD-specific TCI control command on SBFD symbols, e.g., on condition that the DCI is received within Y slots or symbols after receiving the most-recent SBFD-specific TCI control command.

According to one solution, the WTRU may determine that the indicated TCI state (e.g., by the DCI) is associated with a SBFD symbol type, on condition that the DCI is received via a second CORESET index (e.g., except CORESET #0, CORESET index 0, e.g., that may be at least used for initial access) and/or a second search space index (e.g., that may not be a common-search space (CSS)). In that case, the WTRU may associate the indicated TCI state for one communication direction (e.g., either UL transmission, or DL reception), where the one communication direction the WTRU applies may be (pre-) configured or (separately) indicated by the gNB. In an example, the WTRU may associate the indicated TCI state for DL receptions (e.g., on condition that the one communication direction is configured or indicated as a DL direction), while the WTRU may continue to use a previously indicated TCI state in association with SBFD symbols for UL transmissions. In one example, the WTRU may determine that the indicated TCI state (e.g., by DCI) is associated with a non-SBFD symbol type, on condition that the DCI is received via a CORESET #0 and/or a common search-space.

In a fourth example, determination of a SBFD or non-SBFD symbol type associated with a TCI state may be based on the radio network temporary identifier (RNTI) of the CRC scrambled DCI indicating the TCI state. In one solution, the WTRU may determine that the indicated TCI state is associated with a non-SBFD symbol type, on condition that the DCI is received based on determining (e.g., detecting) that the DCI (e.g., a CRC part of the DCI) is scrambled with a first RNTI (e.g., cell RNTI (C-RNTI) assigned to the WTRU, is a non-SBFD RNTI). In that case, the WTRU may associate the indicated TCI state for UL transmissions and/or DL receptions for (at least) one symbol type, e.g., for non-SBFD symbols only, while the WTRU may continue to use a TCI state indicated by a most-recent SBFD-specific TCI control command on SBFD symbols, e.g., on condition that the DCI is received within Y slots or symbols after receiving the most-recent SBFD-specific TCI control command.

Conversely, or in addition, the WTRU may determine that the indicated TCI state (e.g., by the DCI) is associated with a SBFD symbol type, on condition that the DCI is received based on determining (e.g., detecting) that the DCI (e.g., a CRC part of the DCI) is scrambled with a second RNTI (e.g., other than the C-RNTI, a SBFD-RNTI). In that case, the WTRU may associate the indicated TCI state for one communication direction (e.g., either UL transmission, or DL reception), where the one communication direction the WTRU applies may be (pre-) configured or (separately) indicated by the gNB. In an example, the WTRU may associate the indicated TCI state for DL receptions (e.g., on condition that the one communication direction is configured or indicated as a DL direction), while the WTRU may continue to use a previously indicated TCI state in association with SBFD symbols for UL transmissions.

In a fifth example, determination of a SBFD or non-SBFD symbol type associated with a TCI state may be based on an FD (e.g., SBFD) related configuration, an explicit indication, and/or a DCI type (e.g., DCI format, DCI size). In one embodiment, the WTRU may determine that the indicated TCI state (e.g., by the DCI) is associated with a non-SBFD symbol type, on condition that a first explicit indication or configuration (e.g., in relation to the SBFD configuration) is received and/or the DCI may be based on a first DCI type (e.g., DCI format, DCI size). In that case, the WTRU may associate the indicated TCI state for UL transmissions and/or DL receptions for (at least) one symbol type, e.g., for non-SBFD symbols only, while the WTRU may continue to use a TCI state indicated by a most-recent SBFD-specific TCI control command on SBFD symbols, e.g., on condition that the DCI is received within Y slots or symbols after receiving the most-recent SBFD-specific TCI control command.

Conversely, or in addition, the WTRU may determine that the indicated TCI state (e.g., by the DCI) is associated with a SBFD symbol type, on condition that a second explicit indication or configuration (e.g., in relation to the SBFD configuration) is received and/or the DCI may be based on a second DCI type (e.g., DCI format, DCI size). In that case, the WTRU may associate the indicated TCI state for one communication direction (e.g., either UL transmission, or DL reception), where the one communication direction the WTRU applies may be (pre-) configured or (separately) indicated by the gNB. In an example, the WTRU may associate the indicated TCI state for DL receptions using SBFD symbols (e.g., on condition that the one communication direction is configured or indicated as a DL direction), while the WTRU may continue to use a previously indicated TCI state in association with SBFD symbols for UL transmissions.

Embodiments for dynamic UL beam determination on condition that a DL beam is selected will now be described. In one embodiment, e.g., on SBFD symbol(s), a WTRU may perform a dynamic UL TCI (or beam) determination for a best UL TCI (or beam) selection, as paired with a DL beam, on condition that a DL beam is chosen or indicated (e.g., by a gNB). In an example, each TCI state may have more than one (e.g., two) QCL sources, and one of them is indicated as a default TCI state to be used for a non-SBFD symbol type (e.g., in FIG. 5 as TCI #3 indicated by DCI1). When a DL reception associated with a first TCI state (e.g., the default TCI state, a first RS of two QCL sources associated with the first TCI state) is scheduled on an SBFD symbol type, the WTRU may (be configured to) select a second TCI state (or the other one of the two QCL sources of the first TCI state) for a UL transmission.

In one solution, e.g., on SBFD symbol(s), a WTRU may perform a dynamic DL TCI (or beam) determination for a best DL TCI (or beam) selection, as paired with an UL beam, on condition that an UL beam is chosen or indicated (e.g., by a gNB). In an example, each TCI state may have more than one (e.g., two) QCL sources, and one of them is indicated as a default TCI state to be used for non-SBFD symbol type (e.g., in FIG. 5 as TCI #3 indicated by DCI1). When an UL transmission associated with a first TCI state (e.g., the default TCI state, a first RS of two QCL sources associated with the first TCI state) is scheduled on an SBFD symbol type, the WTRU may (be configured to) select a second TCI state (or the other one of the two QCL sources of the first TCI state) for a DL reception.

Embodiments for dynamic beam-domain fallback to a beam used for non-SBFD symbol type are disclosed. In one embodiment, a WTRU may (be configured to) determine to use a non-SBFD type TCI (or beam), even on SBFD symbol(s), on condition that the WTRU receives an indication (e.g., from a gNB) to use such a non-SBFD type TCI (e.g., in FIG. 5, TCI #3 indicated by DCI1) on SBFD symbol(s), and/or an indication that there are no UL transmissions on the SBFD symbol(s). Using the non-SBFD type TCI (or beam) on SBFD symbol(s) may be referred to as a beam-domain fallback behavior. The WTRU may receive an indication or configuration on whether to apply (e.g., enable) this beam-domain fallback behavior. In an example, this dynamic beam-domain fallback behavior may be indicated by the TCI-indication (or TCI-updating) DCI without PDSCH assignment, where a control signal at least including the beam-domain fallback indication may be indicated to the WTRU via reusing one or more disabled fields by the DCI (e.g., in FIG. 5, DCI1, DCI2) without PDSCH assignment (e.g., PDSCH scheduling). In an example, a TCI-activation command (e.g., via a MAC-CE) may indicate (e.g., deliver) the beam-domain fallback behavior, for example, in addition to activating the set of activated TCI states.

Embodiments for using a TCI pattern across SBFD symbol type and non-SBFD symbol type are disclosed. In one embodiment, a WTRU may receive a TCI application pattern across different symbol types (e.g., SBFD or non-SBFD) in a time-domain, where the TCI application pattern may include which TCI state (e.g., in FIG. 5, TCI #2) is to be used for one communication direction (e.g., DL reception) on SBFD symbols and which TCI state (e.g., FIG. 5, TCI #3) is to be used for another (e.g., the other) communication direction (e.g., UL transmission) on SBFD symbols as well as for both DL receptions and UL transmissions on non-SBFD symbols. The TCI application pattern may be constructed (e.g., signaled, indicated) based on a TDD and/or SBFD pattern period(s), e.g., where the TCI application pattern may be applicable for every M-th periodicity of the TDD and/or SBFD pattern period(s), e.g., following an integer multiple of the configured TDD and/or SBFD pattern periodicity. In an example, a TCI-activation command (e.g., via a MAC-CE) may indicate (e.g., deliver) the TCI application pattern and/or a simultaneous TCI (e.g., beam) update(s) for both symbol types, e.g., in addition to activating the set of activated TCI states.

Fallback TCI pattern in SBFD symbols embodiments are described. In one embodiment, a WTRU may receive one or more fallback TCI application patterns for one or more configured semi-persistent scheduled (SPS) PDSCHs and/or dynamically configured PDSCHs. For example, the WTRU may receive the indication on the fallback TCI application pattern(s) to be used and/or applied via DCI. In an example, the received fallback TCI application pattern may be based on a bitmap indication, where each bit may correspond to a configured PDSCH occasion that is in an SBFD symbol, e.g., within a TDD cycle. By way of example, the bits in the configured fallback TCI application pattern may be ordered in association with the time instances corresponding to the configured PDSCH.

In one example, in case a bit in the configured fallback TCI application pattern has a first value (e.g., value zero), the WTRU may use the configured SBFD TCI state for reception of a configured PDSCH in the associated PDSCH occasion in the configured SBFD symbol. In another example, in case a bit has a second value (e.g., value one), the WTRU may use the configured non-SBFD TCI state for reception of configured PDSCH in the associated PDSCH occasion, although the associated PDSCH occasion may be configured in an SBFD symbol. As such, the WTRU may receive the fallback TCI pattern for the PDSCH occasions in SBFD symbols, where the WTRU is indicated to use non-SBFD DL TCI state. The solutions provided for PDSCH reception occasions may be used for all types of DL reception occasions.

Embodiments using MAC-CE based separate indications are also disclosed. In one embodiment, based on receiving a MAC-CE (e.g., the TCI-activation MAC-CE command, or a new MAC-CE) activating a set of TCI states (out of a common RRC pool of TCI states, e.g., the plurality of TCI states), the WTRU may determine that the set of TCI states is to be associated with which symbol type (SBFD or non-SBFD), based on at least one of the following:

(1) Based on the MAC-CE reception timing according to symbol type. For example, when the MAC-CE is received in SBFD symbol(s), the WTRU may determine that the set of TCI states is associated with the SBFD symbol type. When the MAC-CE is received in non-SBFD symbol(s), the WTRU may determine that the set of TCI states is associated with the non-SBFD symbol type.

(2) Based on a time-offset after the MAC-CE reception, e.g., where the time-offset may be configured or indicated, or determined based on a rule (e.g., based on a BAT, e.g., in the examples of FIG. 5, T_BAT, T_BAT2). For example, when a symbol based on a time-offset after the MAC-CE belongs to SBFD symbol(s), the WTRU may determine that the set of TCI states is associated with the SBFD symbol type. When a symbol based on a time-offset after the MAC-CE belongs to non-SBFD symbol(s), the WTRU may determine that the set of TCI states is associated with the non-SBFD symbol type.

(3) Based on an ACK-transmission timing in response to the MAC-CE reception. For example, when a symbol based on (e.g., a time-offset after, a first symbol of) an ACK transmission timing in response to receiving the MAC-CE belongs to SBFD symbol(s), the WTRU may determine that the set of TCI states is associated with the SBFD symbol type. When a symbol based on (e.g., a time-offset after, a first symbol of) an ACK transmission timing in response to receiving the MAC-CE belongs to non-SBFD symbol(s), the WTRU may determine that the set of TCI states is associated with the non-SBFD symbol type.

(4) Based on the MAC-CE reception timing according to pre-defined or pre-configured symbol(s), e.g., a pattern of symbol indexes within TDD and/or SBFD pattern period(s). For example, when the MAC-CE is received in symbol(s) belonging to a first set of symbol indexes, the WTRU may determine that the set of TCI states is associated with the SBFD symbol type. When the MAC-CE is received in symbol(s) belonging to a second set of symbol indexes, the WTRU may determine that the set of TCI states is associated with the non-SBFD symbol type. The second set of symbol indexes may be determined as symbol indexes other than the first set of symbol indexes.

(5) Based on an LCID of the MAC-CE. For example, when the MAC-CE is received with a first logical channel ID (LCID) of the MAC-CE, the WTRU may determine that the set of TCI states is associated with the SBFD symbol type. When the MAC-CE is received with a second LCID of the MAC-CE, the WTRU may determine that the set of TCI states is associated with the non-SBFD symbol type.

(6) Based on an explicit indicator (e.g., 1-bit) in the MAC-CE, e.g., in addition to the CORESETpoolID, or by reusing the CORESETpoolID bit, or by joint-encoding with a CORESETpoolID field. For example, when the MAC-CE is received with the explicit indicator set to a first value, the WTRU may determine that the set of TCI states is associated with the SBFD symbol type. When the MAC-CE is received with the explicit indicator set to a second value, the WTRU may determine that the set of TCI states is associated with the SBFD symbol type.

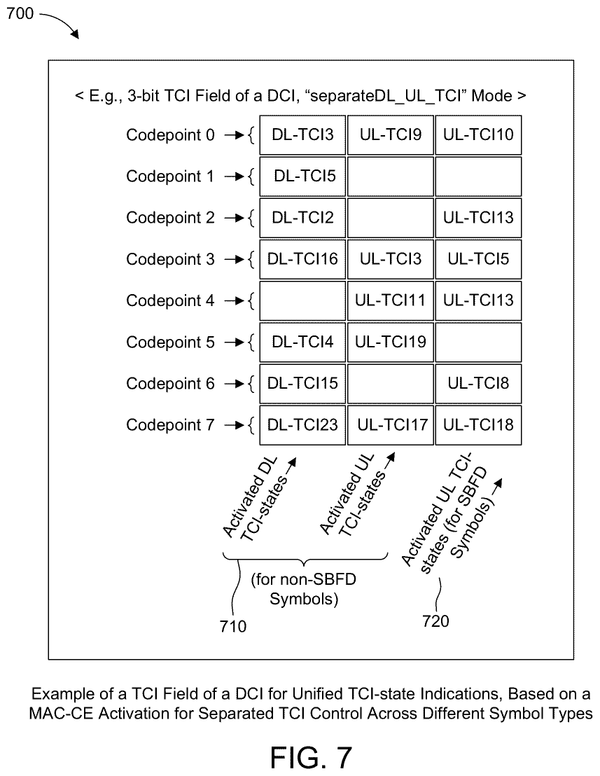

Referring to FIG. 7, an example of a TCI field 700 of a DCI for unified TCI state indications is shown. In certain embodiments, the WTRU may (be configured to) receive a MAC-CE (e.g., the TCI-activation MAC-CE command or a new MAC-CE) activating a first set of TCI states 710 (out of a common RRC pool, e.g., the plurality of TCI states) for being used in non-SBFD symbols and (separately) a second set of TCI states 720 for being used in SBFD symbols. FIG. 7 shows the case when the first mode for unified TCI (e.g., SeparateDLULTCI mode, a parameter of ‘unifiedTCIstateType’ set to ‘separate’) is configured, where the first two columns of TCI field 700 may correspond to the first set of TCI states 710 (comprising activated DL-TCI states (in the first column) and activated UL-TCI states (in the second column) as being paired across codepoints, applicable for non-SBFD symbols). The last column of TCI field 700 may correspond to the second set of TCI states 720 including (additionally) activated TCI states applicable for SBFD symbols. In an example, the WTRU may transmit a first UL channel or signal (e.g., PUSCH, PUCCH, SRS) scheduled on non-SBFD symbol(s) using a first indicated TCI state (e.g., UL-TCI9, 14, 3, 11, 19, or 17) belonging to the second column, and/or receive a first DL channel or signal (e.g., PDSCH, PDCCH, CSI-RS) scheduled on non-SBFD symbol(s) using a second indicated TCI state (e.g., DL-TCI3, 5, 2, 16, 4, 15, or 23) belonging to the first column. In the example of FIG. 7, the WTRU may transmit a second UL channel or signal scheduled on SBFD symbol(s) using a third indicated TCI state (e.g., UL-TCI10, 13, 5, 13, 8, or 18) belonging to the third column, and/or receive a second DL channel or signal scheduled on SBFD symbol(s) using the (e.g., same) second indicated TCI state belonging to the first column (e.g., because no explicit column for DL reception for SBFD symbol(s) was activated by the MAC-CE, as an example).

In another example, the WTRU may receive the MAC-CE including the last column to activate (e.g., only) activated DL-TCI states (instead of UL-TCI states) applicable for SBFD symbols. In another example, the WTRU may receive the MAC-CE including an additional last column (not shown) designating DL-TCI states so that DL-TCI states and UL-TCI states (as being paired similar to the non-SBFD symbol type case) may be activated applicable for SBFD symbols. This may provide benefits in terms of flexibility and efficiency in that the gNB may additionally activate either UL-TCI states or DL-TCI states (or both) to be used for SBFD symbols, selectively.

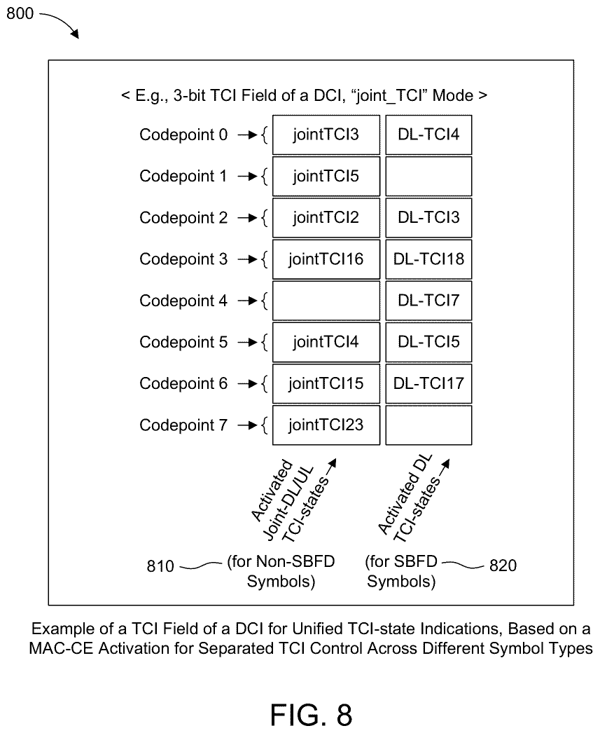

Referring to FIG. 8, another example of a TCI field 800 of a DCI for unified TCI state indications is shown. FIG. 8 shows the case when the second mode for unified TCI (e.g., JointTCI mode, a parameter of ‘unifiedTClstateType’ set to ‘joint’) is configured, where the first column may correspond to the first set of TCI states 810 (including activated joint-TCI states each for use in both DL Rx and UL Tx) applicable for non-SBFD symbols, and the last column may correspond to the second set of TCI states 820 including (additionally) activated TCI states applicable for SBFD symbols, where the second set of TCI states 820 may only include DL-TCI states (e.g., due to the signal interference (SI) for UL Rx at the gNB as FIG. 5). In another example embodiment, the second set of TCI states 820, while not shown, may be designated for UL-TCI states (e.g., only) to have separated UL-TCI states to be used for SBFD symbols while maintaining the ability to use the same joint TCI states (even for SBFD symbols) activated in the first column (as for non-SBFD symbol type). In yet another example solution, the second set of TCI states 820 may include joint-TCI states (not shown) to have a separated joint-TCI states to be used for SBFD symbols while to use the first set of TCI states in case of UL Tx or DL Rx in non-SBFD symbols. This may provide benefits in terms of flexibility and efficiency in that the gNB may additionally activate either UL-TCI states or DL-TCI states or another set of joint-TCI states to be used for SBFD symbols, selectively.

In an example, the WTRU may transmit a first UL channel or signal (e.g., PUSCH, PUCCH, SRS) scheduled on non-SBFD symbol(s) using a first indicated TCI state 810 (e.g., jointTCI3, 5, 2, 16, 4, 15, or 23) belonging to the first column, and/or receive a first DL channel or signal (e.g., PDSCH, PDCCH, CSI-RS) scheduled on non-SBFD symbol(s) using the (e.g., same) first indicated TCI state 810 (e.g., as a joint TCI) belonging to the first column. The WTRU may receive a second DL channel or signal scheduled on SBFD symbol(s) using a second indicated TCI state 820 (e.g., DL-TCI4, 3, 18, 7, 5, or 17) belonging to the second column, and/or transmit a second UL channel or signal scheduled on SBFD symbol(s) using the (e.g., same) first indicated TCI state 810 belonging to the first column (e.g., because no explicit column for UL transmission for SBFD symbol(s) was activated by the MAC-CE, as an example).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for a wireless transmit unit (WTRU), the method comprising:
receiving configuration information for subband full duplex (SBFD) communication and a plurality of transmission configuration indicator (TCI) states;
receiving a TCI activation command indicating an activated set of TCI states of the configured plurality of TCI states;
receiving a first downlink control information (DCI) indicating a first TCI state of the activated set of TCI states;
associating the first TCI state with non-SBFD symbol transmissions or receptions with a network; and
sending to, or receiving from, the network in at least one non-SBFD symbol, a first signal using the first TCI state;
receiving a second DCI indicating a second TCI state of the activated set of TCI states;
associating the second TCI state with SBFD symbol transmissions or receptions;
receiving, in at least one non-SBFD symbol, a second signal using the first TCI state; and
receiving, in at least one SBFD symbol, a third signal using the second TCI state.

2. The method of claim 1, wherein the at least one SBFD symbol comprises a subband-non-overlapping SBFD symbol including one or more SBFD subbands.

3. The method of claim 1, wherein the at least one non-SBFD symbol comprises a time division duplex (TDD) symbol without SBFD subbands.

4. The method of claim 1, wherein the first, second or third signals comprise any one of a control channel, a data channel or a reference signal.

5. The method of claim 1, wherein associating the first TCI state with non-SBFD symbol transmissions or receptions is based on one or more of: a symbol type in which the first DCI is received, an identity or type of CORSET, a search space and search space set in which the first DCI is received, a reception timing of the first DCI or time offset from the reception time of the first DCI, the configuration information for SBFD communication, an explicit indication from the network, or a DCI type of the first DCI.

6. The method of claim 1, wherein associating the second TCI state with SBFD symbol transmissions or receptions is based on one or more of: a symbol type in which the second DCI is received, an identity or type of CORSET, a search space and search space set in which the second DCI is received, a reception timing of the second DCI or time offset from the reception time of the second DCI, the configuration information for SBFD communication, an explicit indication from the network, or a DCI type of the second DCI.

7. The method of claim 1, wherein the first TCI state comprises a unified TCI (UTCI) state for transmitting or receiving a signal on either or both of SBFD or non-SBFD symbols.

8. The method of claim 1, wherein the configuration information includes a mapping between one or more codepoints of a DCI field and one or more TCI states of the plurality of TCI states.

9. The method of claim 8, wherein the first DCI and the second DCI includes the DCI field, wherein each of the one or more TCI states is applicable after a time duration based on a beam application time (BAT) parameter.

10. A wireless transmit unit (WTRU) comprising:
a processor and a transceiver operatively coupled to the processor, the processor and transceiver configured to:
receive configuration information for subband full duplex (SBFD) communication and a plurality of transmission configuration indicator (TCI) states;
receive a TCI activation command indicating an activated set of TCI states of the configured plurality of TCI states;
receive a first downlink control information (DCI) indicating a first TCI state of the activated set of TCI states;
associate the first TCI state with non-SBFD symbol transmissions or receptions with a network; and
send to, or receive from, the network in at least one non-SBFD symbol, a first signal using the first TCI state;
receive a second DCI indicating a second TCI state of the activated set of TCI states;
associate the second TCI state with SBFD symbol transmissions or receptions;
receive, in at least one non-SBFD symbol, a second signal using the first TCI state; and
receive, in at least one SBFD symbol, a third signal using the second TCI state.

11. The WTRU of claim 10, wherein the at least one SBFD symbol comprises a subband non-overlapping SBFD symbol including one or more SBFD subbands.

12. The WTRU of claim 10, wherein the second TCI state is associated with SBFD symbol transmissions or receptions based on one or more of: a symbol type in which the second DCI is received, an identity or type of CORSET, a search space and search space set in which the second DCI is received, a reception timing of the second DCI or time offset from the reception time of the second DCI, the configuration information for SBFD communication, an explicit indication from the network, or a DCI type of the second DCI.

13. The WTRU of claim 10, wherein the configuration information includes a mapping between one or more codepoints of a DCI field and one or more TCI states of the plurality of TCI states.

14. A method for a wireless transmit unit (WTRU), the method comprising:
receiving configuration information for subband full duplex (SBFD) communication and a plurality of transmission configuration indicator (TCI) states;
receiving a TCI activation command indicating an activated set of TCI states of the configured plurality of TCI states;
receiving a first downlink control information (DCI) indicating a first TCI state of the activated set of TCI states;
associating the first TCI state with non-SBFD symbol transmissions or receptions with a network;
sending to, or receiving from, the network in at least one non-SBFD symbol, a first signal using the first TCI state;
receiving a second DCI indicating a second TCI state of the activated set of TCI states;
associating the second TCI state with SBFD symbol transmissions or receptions;
sending, in at least one non-SBFD symbol, a second signal using the first TCI state; and
sending, in at least one SBFD symbol, a third signal using the second TCI state.

15. The method of claim 14, wherein the first, second or third signals comprise any one of a control channel, a data channel or a reference signal.

16. The method of claim 14, wherein associating the first TCI state with non-SBFD symbol transmissions or receptions is based on one or more of: a symbol type in which the first DCI is received, an identity or type of CORSET, a search space and search space set in which the first DCI is received, a reception timing of the first DCI or time offset from the reception time of the first DCI, the configuration information for SBFD communication, an explicit indication from the network, or a DCI type of the first DCI.

17. The method of claim 14, wherein associating the second TCI state with SBFD symbol transmissions or receptions is based on one or more of: a symbol type in which the second DCI is received, an identity or type of CORSET, a search space and search space set in which the second DCI is received, a reception timing of the second DCI or time offset from the reception time of the second DCI, the configuration information for SBFD communication, an explicit indication from the network, or a DCI type of the second DCI.

18. The method of claim 14, wherein the configuration information includes a mapping between one or more codepoints of a DCI field and one or more TCI states of the plurality of TCI states.
